(19) United States
(12) Patent Application Publication
(10) Pub. No.: US 2011/0062746 A1
(43) Pub. Date: Mar. 17, 2011

(54) METHOD AND APPARATUS FOR PROTECTING INTERIOR OF CONVERTIBLE CAR

(75) Inventor: Patricia P. DRIGGERS, Fayetteville, NC (US)

(73) Assignee: EMSCO, Fayetteville, NC (US)

(21) Appl. No.: 12/883,964

(22) Filed: Sep. 16, 2010

Related U.S. Application Data
(60) Provisional application No. 61/243,029, filed on Sep. 16, 2009.

(51) Int. Cl. B60J 7/20

(52) U.S. Cl. 296/136.03

(57) ABSTRACT

The disclosure describes an apparatus and method for protecting the interior of a convertible car or other open-topped vehicle. The apparatus covers the interior portion of a convertible car, leaving the exterior exposed, and attaches by means of one or more attachment devices. Suitable attachment devices may include elastic or adjustable straps, suction cups, and the like. The cover folds for easy storage when not in use. The cover may include an edge material to aid or assist in folding.

### CROSS-REFERENCE TO RELATED APPLICATIONS

This application claims priority under 35 U.S.C. §119(e) to provisional U.S. Patent Application No. 61/243,029, filed on Sep. 16, 2009, the disclosure of which is expressly incorporated by reference herein in its entirety.

### BACKGROUND

1. Field of the Present Disclosure

The present disclosure is directed to a method and apparatus for protecting the interior of a convertible car and/or keeping interior surfaces of a convertible car cooler when the top is down.

2. Related Art

Convertible cars allow the driver to put the top down and enjoy beautiful weather. When the weather is inclement, the driver can put the top up and thereby be protected from the elements. A driver may also put the top up when parking her car to protect the interior from damage by the sun, sudden rain showers, bird droppings, and the like. The process of putting the top up and taking it down, however, is somewhat time consuming and laborious. Repeated operation of the top will also result in increased wear and tear of the associated mechanism. Such effort is warranted if the driver is parking the convertible car overnight, for example, but it is inconvenient if the driver is only parking the car for a few minutes, such as when running into a store to make a small purchase. In this situation, the possibility for damage to the interior of the car is nonetheless present.

Accordingly, there is a need for a method and apparatus for protecting the interior of a convertible car that is free from the hassle of putting up the car's top.

### SUMMARY

The present disclosure meets the foregoing need and allows a driver to protect the interior of his vehicle without using the vehicle's top, which results in a significant increase in convenience, protection of the interior, avoidance of wear and tear and other advantages apparent from the discussion herein.

Accordingly, one aspect of the present disclosure provides an apparatus for protecting the interior of a convertible car. The apparatus includes a cover body that is substantially planar, water-resistant, and opaque. When in use, the cover body substantially covers the interior of a convertible car and leaves the exterior substantially uncovered. The apparatus also include one or more attachment device for attaching and detaching the cover body from the car.

The apparatus may include a side overhang that extends past an edge of the car's interior or an extension that covers the car's dashboard. The cover body may have a one shape when it is folded and a different shape when it is unfolded and placed over the interior of the car. The attachment device may be a loop, an adjustable loop, an adjustable strap, or a suction cup. The cover body may include a 100% nylon fabric and one or more metal rods, or the cover body may include a 100% nylon fabric and one or more rods made of 80% resin and 20% fiber glass.

Another aspect of the present disclosure describes a method for protecting the interior of a convertible car. The method includes attaching a cover body to the convertible car with an attachment device, substantially covering the interior of the car with the cover body while leaving the exterior of the car substantially uncovered, and attaching the cover body to the car with another attachment device.

The method may include extending a side overhang of the cover body past an edge of the car's interior or extending an extension to cover the car's dashboard. The method may include changing the cover body from a first shape when it is folded to a second shape when it is unfolded. Attachment devices may include a loop, an adjustable loop, an adjustable strap, or a suction cup. The cover body may include a 100% nylon fabric and one or more metal rods, or the cover body may include a 100% nylon fabric and one or more rods made from 80% resin and 20% fiber glass.

Additional features, advantages, and embodiments of the present disclosure may be set forth or apparent from consideration of the following detailed description, drawings, and claims. Moreover, it is to be understood that both the foregoing summary of the present disclosure and the following detailed description are exemplary and intended to provide further explanation without limiting the scope of the present disclosure as claimed.

### BRIEF DESCRIPTION OF THE DRAWINGS

The accompanying drawings, which are included to provide a further understanding of the present disclosure, are incorporated in and constitute a part of this specification, illustrate embodiments of the present disclosure and together with the detailed description serve to explain the principles of the present disclosure. No attempt is made to show structural details of the present disclosure in more detail than may be necessary for a fundamental understanding of the present disclosure and the various ways in which it may be practiced. In the drawings:

FIG. 1 shows one embodiment of a convertible car cover in an operational or deployed configuration;

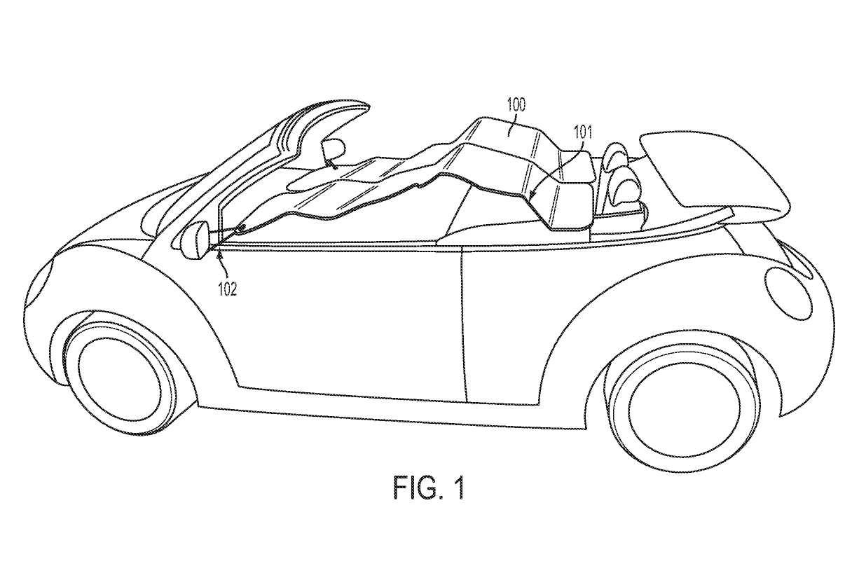

FIG. 2 shows a close-up of the convertible car cover in FIG. 1;

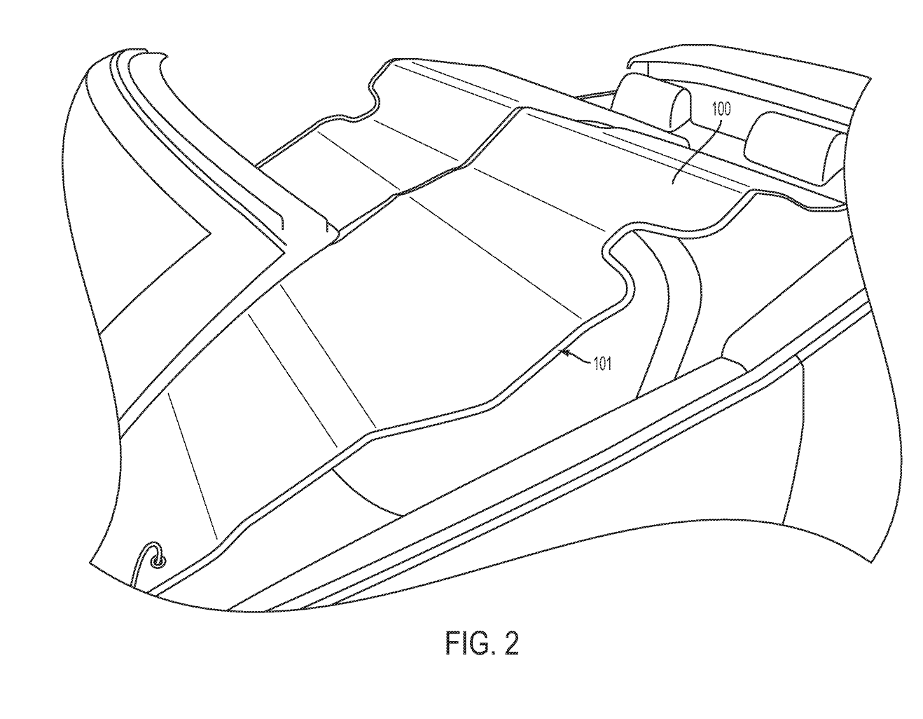

FIG. 3 shows the convertible car cover of FIG. 1 in a partially deployed configuration;

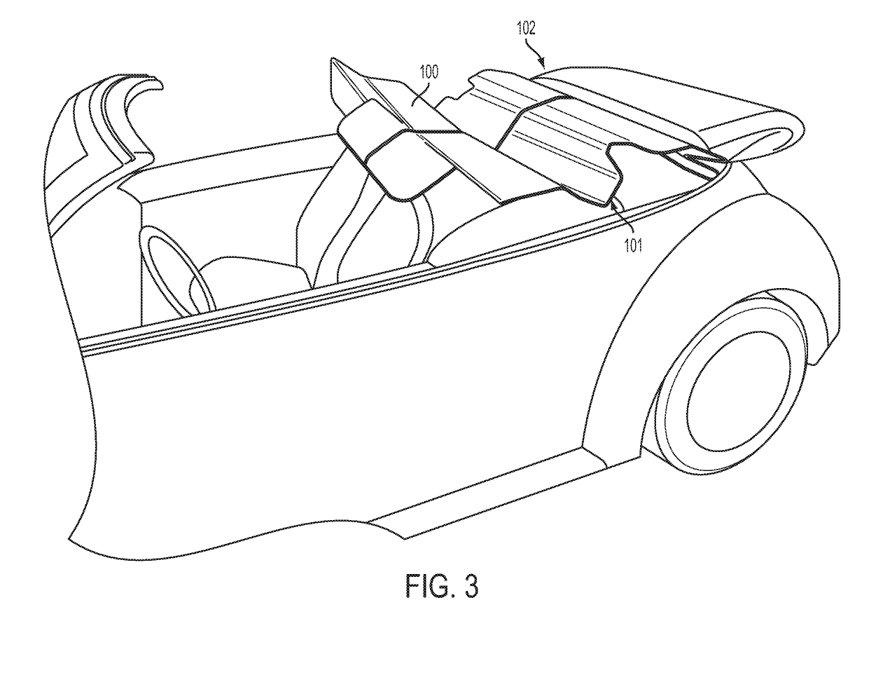

FIG. 4 shows an additional embodiment of a convertible car cover according to the teachings of the present disclosure;

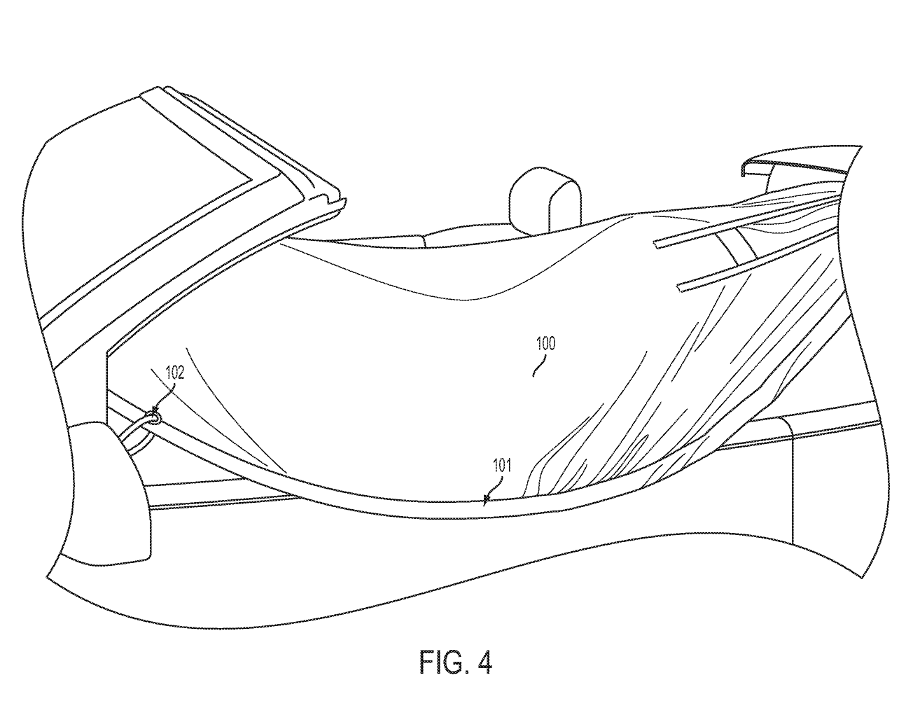

FIG. 5 shows a different view of the convertible car cover in FIG. 4; and

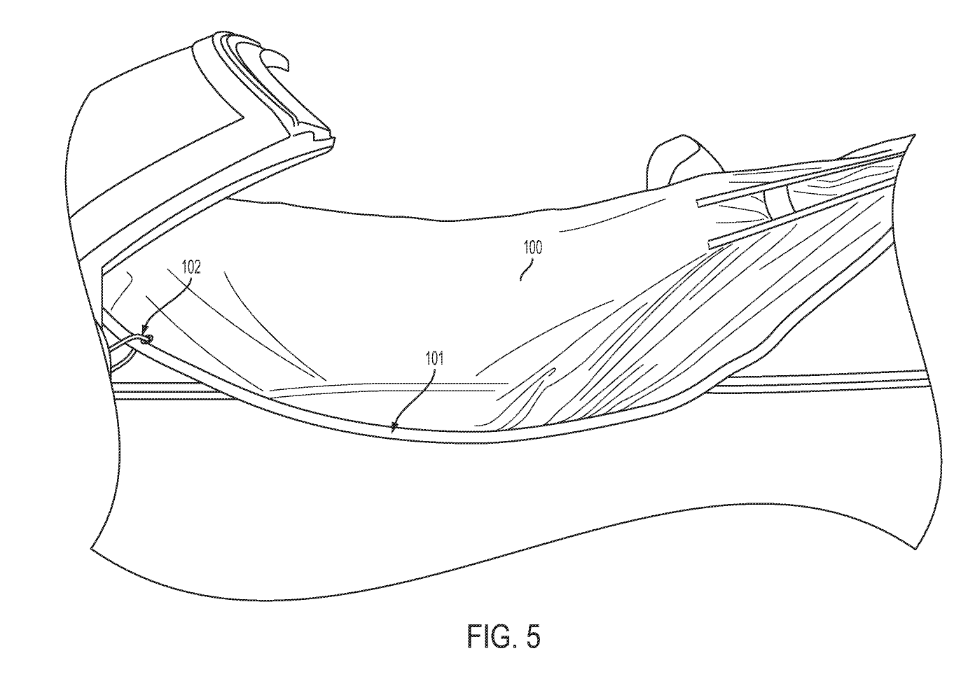

FIG. 6 shows a different view of the convertible car cover in FIG. 4

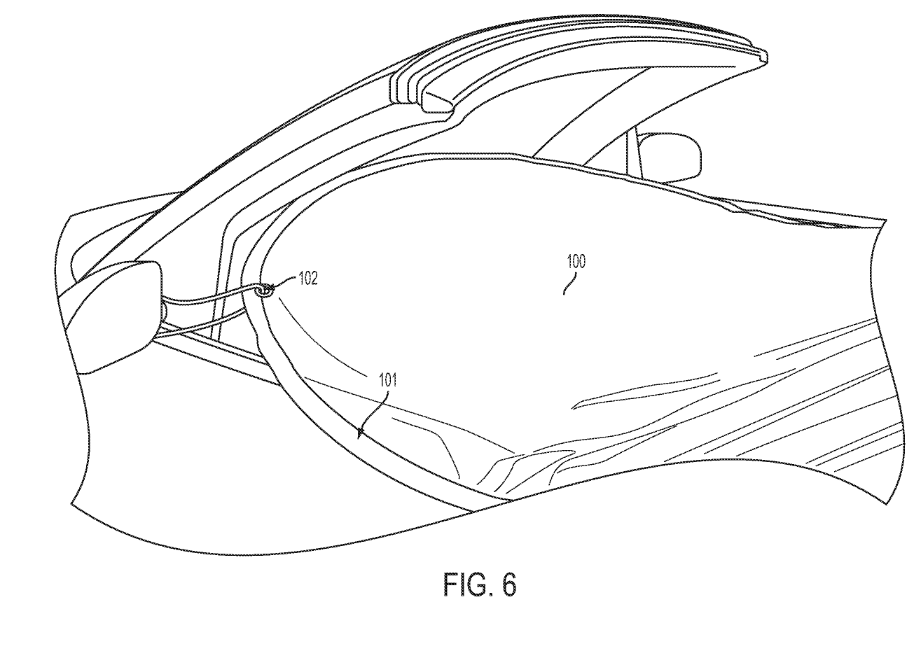

### DETAILED DESCRIPTION

The embodiments of the present disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the present disclosure. The examples used herein are intended merely to facilitate an understanding of ways in which the present disclosure may be practiced and to further enable those of skill in the art to practice the embodiments of the present disclosure. Accordingly, the examples and embodiments herein should not be construed as limiting the scope of the present disclosure, which is defined solely by the appended claims and applicable law. Moreover, it is noted that like reference numerals represent similar parts throughout the several views of the drawings.

According to the present disclosure, a cover may be deployed on a convertible car when the car's top is in the “down” position. The cover blocks the sun and helps keep the interior of the car cool. The cover may also prevent or reduce,damage to the interior by the sun's rays. The cover may further protect the interior of the car from other environmental hazards, such as bird droppings and falling leaves. Moreover, use of the cover avoids additional wear and tear on the top's operating mechanism.

The cover 100 may be made from any suitable, opaque material, such as, e.g., canvas, vinyl, or cardboard. The cover may also be made from a material that is insulating and highly reflective. For example, the cover may have a “sandwich” or ABA structure. In this arrangement, the outer “A” layers may be formed from a highly reflective material, such as a metalized film or foil laminate. The inner “B” layer may consist predominately of air held in small cells by a plastic film or other suitable material. The outer layer acts to reflect sunlight away from the otherwise exposed interior of the car, while the inner layer insulates the interior of the car from any heating of the outer layer by the sun. However, the cover is contemplated to have other configurations. For example, the cover may be made from 100% polyester.

The cover may be structured and arranged such that it is easily stored when not deployed to protect the interior of the car. For example, the cover may have hinges, creases, joints, or the like that allow it to be folded for storage purposes.

The cover may also have a rod or other material attached to or embedded in its edges 101. The rod may act to keep the cover weighed down so that it is not easily blown out of position by the wind. The rod may also function to assist with storing the cover. For example, twisting the rod may cause the cover to fold itself into a smaller, more compact, and more easily stored shape. In other words, the rod may assume a first shape in a folded arrangement and may easily assume a second shape in an extended arrangement. The rod may, for example, be made of 80% resin and 20% fiber glass, or from steel, or from any other suitable material known to one skilled in the art. Other suitable storage configurations and edge materials are contemplated and within the spirit and scope of the present disclosure and claims.

Alternatively, the cover may be provided on a roll so that the driver unrolls the cover to deploy it and rolls the cover to store it. Such a roll may be operated by an “automatic” or spring-powered retractor, a motorized retractor, a manually cranked retractor, or the driver may merely need to roll up the cover in some other fashion, e.g., like a roll of wrapping paper.

The cover may be provided with means for attachment 102 to the car. As most automobiles are greater in length (i.e. from front to back) than they are in width (i.e. from side to side), a cover may be likewise proportioned. The shorter sides shall be referred to as the “ends” while the longer sides shall be referred to as the “sides.” When the cover is deployed, one end is positioned near the front of the passenger compartment, preferably on or near the car's dashboard, and one end is positioned near the rear of the passenger compartment, preferably to the rear of the rear-most seats. The dashboard end of the cover may include elastic straps that wrap around the car's side rearview mirrors. The rear end of the cover may include suction cups to adhere to a suitable surface of the car. Together, the elastic straps and suctions sups attach the cover to the car and hold the cover in place.

Alternate means of attachment are contemplated and within the scope of the present disclosure. For example, elastic or other straps may be provided at both ends of the cover. The cover may include multiple attachment means, e.g. a suction cup and an elastic strap, at each corner. The cover may be fixedly attached to the car, either as a factory-installed accessory or as an after-market accessory. In such an aspect, one end of the cover may be fixedly attached while the opposite end may include appropriate means for attaching to the corresponding end of the car. The cover may also include additional attachment means. For example, straps may be positioned along the sides for attaching to a suitable feature of the car, such as a door handle.

The cover may also include means to secure or hold the cover when not in use. For example, a cover that folds may be held in the folded position by straps that attach by tying or with snaps, buckles, Velcro®, or the like. A rolling cover may be held in a rolled-up position by the action of its retractor, included a spring, lock, latch, or the like. A rolled-up cover may also be held closed by straps such as those described above.

A cover may include one or more additional segments that extend beyond the main body of the cover. For example, a cover may include side overhangs that extend past the edges of the interior of car, dropping down, e.g., over the top portions of the doors. Side overhangs may be structured and arranged to direct runoff (e.g. from a light rain) from the main body of the cover to the outside of the car. As another example, a segment may be structured and arranged to cover and protect the dashboard of the car. Additional types of segments are contemplated and are within the scope and spirit of the present disclosure.

While a cover has been described in connection with a convertible car, one of ordinary skill in the art will recognize that the operating principles above can be applied to create a cover for any open-top vehicle. For example, a cover as described above could be used to keep the interior of a motorboat cool while docked. A cover could also be used to keep cool the seat of a Jet Ski®, motorcycle, scooter, golf cart, ATV, bicycle, or the like.

While the present disclosure has been described in terms of exemplary embodiments, those skilled in the art will recognize that the present disclosure can be practiced with modifications in the spirit and scope of the appended claims. These examples given above are merely illustrative and are not meant to be an exhaustive list of all possible designs, embodiments, applications or modifications of the present disclosure.

What is claimed is:

1. An apparatus for protecting an interior of a convertible car, the apparatus comprising:
a cover body structured and arranged to be substantially planar, water-resistant, and opaque, the cover body configured to substantially cover an interior of a convertible car and to leave an exterior of the convertible car substantially uncovered; and
at least one attachment device configured to removably attach the cover body to the convertible car.

2. The apparatus of claim 1, further comprising a side overhang structured and arranged to extend past an edge of the interior of the convertible car.

3. The apparatus of claim 1, further comprising an extension structured and arranged to cover a dashboard of the convertible car.

4. The apparatus of claim 1, wherein the cover body is configured to have a first shape in a folded arrangement to a second shape in an extended arrangement.

5. The apparatus of claim 1, wherein the at least one attachment device comprises a loop.

6. The apparatus of claim 1, wherein the at least one attachment device comprises an adjustable loop.

7. The apparatus of claim 1, wherein the at least one attachment device comprises an adjustable strap.

8. The apparatus of claim 1, wherein the at least one attachment device comprises a suction cup.

9. The apparatus of claim 1, the cover body comprising:
fabric, wherein the fabric comprises 100% nylon; and
at least one metal rod.

10. The apparatus of claim 1, the cover body comprising:
fabric, wherein the fabric comprises 100% nylon; and
at least one rod comprising 80% resin and 20% fiber glass.

11. A method for protecting the interior of a convertible car, the method comprising:
attaching a cover body to a convertible car with a first attachment device;
substantially covering an interior of the convertible car with the cover body;
leaving an exterior of the convertible car substantially uncovered; and
attaching the cover body to the convertible car with a second attachment device.

12. The method of claim 11, further comprising extending a side overhang of the cover body past an edge of the interior of the convertible car.

13. The method of claim 11, further comprising extending an extension of the cover body to cover a dashboard of the convertible car.

14. The method of claim 11, further comprising changing the cover body from a first shape in a folded arrangement to a second shape in an extended arrangement.

15. The method of claim 11, wherein at least one of the first attachment device and the second attachment device comprises a loop.

16. The method of claim 11, wherein at least one of the first attachment device and the second attachment device comprises an adjustable loop.

17. The method of claim 11, wherein at least one of the first attachment device and the second attachment device comprises an adjustable strap.

18. The method of claim 11, wherein at least one of the first attachment device and the second attachment device comprises a suction cup.

19. The method of claim 11, the cover body comprising:
fabric, wherein the fabric comprises 100% nylon; and
at least one metal rod.

20. The method of claim 11, the cover body comprising:
fabric, wherein the fabric comprises 100% nylon; and
at least one rod comprising 80% resin and 20% fiber glass.
